(19) United States
(12) Patent Application Publication
(10) Pub. No.: US 2013/0304079 A1
(43) Pub. Date: Nov. 14, 2013

(54) METHOD FOR LABELING A LIVING ORGANISM

(71) Applicant: NATIONAL TAIWAN UNIVERSITY, Taipei (TW)

(72) Inventors: Ta Te Lin, Taipei (TW); Chia Ying Wu, Taipei (TW); En Chen Yang, Taipei (TW); Yi Chan Peng, Taipei (TW); Joe Air Jiang, Taipei (TW)

(73) Assignee: National Taiwan University, Taipei (TW)

(21) Appl. No.: 13/685,622

(22) Filed: Nov. 26, 2012

(30) Foreign Application Priority Data
May 11, 2012 (TW) 101116935

(51) Int. Cl. A01K 11/00

(52) U.S. Cl. CPC A01K 11/005
USPC 606/116

(57) ABSTRACT

The present invention provides a method for labeling a living organism by laser engraving, the method comprising fixing the living organism to a fixation device, coating whole or a part of body surface of the living organism with a paint operable to react with a laser; and reacting the paint with the laser to make a label by color alteration of the paint.

### FIELD OF THE DISCLOSURE

The present disclosure relates, according to some embodiments, to systems, devices, and methods for labeling a living organism, for example, through laser engraving.

### BACKGROUND OF THE DISCLOSURE

During research and observation of an animal and its actions, it is conventional to label and trace the target animal in order to determine its distribution, home range, action patterns, and the like. Considerations or requirements for labeling, may include: the label should not affect or interfere with the way that the animal acts or lives, for example, the label should not destroy the camouflage of the labeled animal; the label should not reduce the lifespan of the target animal; and the label should not be able to be easily removed or damaged. Namely, the purpose of tracing and observation can be achieved while artificial interferences is reduced to minimal.

Often, the labeling method used depends on the target animals, for example, neck collars and leg bands may be used for mammals or birds, and implanted label for fish and reptiles. However, these labels may only be suitable for the animals with large bodies. For animals with small bodies, such as insects, labels may significantly interfere with the animals' actions because of the size and weight of the labels and the difficulty of implanting labels. Conventional method for labeling insects includes processing target insects one-by-one with hand-written numbers or colors. It is difficult to label a large population of insects in a short period of time using the conventional method, especially to a population of social insects such as honey bees and ants. Further, consideration may be given to the effects of the toxicity of hand-writing tools on the target insect and the problems of color maintenance. Therefore, an improved method of labeling populations of living organisms such as insects is desired.

### SUMMARY

Laser engraving applies a laser on a material to generate corrosion, vaporization, and/or optical chemical reaction on the material's surface, therefore forming an imprint on the material. Laser engraving has been applied to various materials such as metal, leather, ceramic, glass, plastics, wood, and the like. Great Britain Patent No. 2,432,340, U.S. Patent Publication No. 2004/0221756, and China Patent No. 101934674 disclose that laser engraving can be applied to a variety of materials, including wood fiber products, thermoset plastics, and dried sea cucumber, respectively.

The present disclosure relates, in some embodiments, to a method for labeling a living organism by laser engraving, the method comprising fixing the living organism, coating whole or a part of a body surface of the living organism with a paint, and reacting the paint with a laser to make a label by color alteration of the paint.

A laser may only react with the paint, but not with the body of the living organism. Any living organism can be labeled by the methods disclosed, but a living organism having a rigid surface on its body may be preferred. For example, the living organism is an animal having an exoskeleton or similar structure.

### BRIEF DESCRIPTION OF THE DRAWINGS

FIG. 1 illustrates a method for labeling a living organism, in accordance with one embodiment of the present disclosure;

FIGS. 2A and 2B illustrate a two-dimensional image signal used as a label, in accordance with one embodiment of the present disclosure;

FIG. 3 illustrates two labels of the two-dimensional image signal of FIG. 2 produced by laser engraving, in accordance with one embodiment of the present disclosure; and

FIGS. 4A and 4B illustrate a honey bee labeled by laser engraving, in accordance with one embodiment of the present disclosure.

### DETAILED DESCRIPTION OF THE EMBODIMENTS

The present disclosure describes methods for labeling a living organism by laser engraving, comprising, for example, fixing the living organism, coating whole or a part of a body surface of the living organism with a paint, and reacting the paint with a laser to make a label by color alteration of the paint.

In some embodiments, a laser may react with applied paint, but not with the body of the living organism. Any living organism can be labeled by the method disclosed, but a living organism having a rigid surface on its body may be preferred. For example, the living organism may be an animal having an exoskeleton or similar structure.

In an embodiment, the living organism may be selected from phylum Mollusca or phylum Arthropoda. However, some animals that do not belong to either of the above phyla but have at least a part of a rigid body surface (i.e. exoskeletons or similar structures), such as chelonian, pangolin, and the like, can be labeled through methods disclosed herein.

In some embodiments, the present method can be applied to a member of the phylum Mollusca, such as shellfish, gastropods, snails, and the like. In some embodiments, a label may be applied to a member of the phylum Arthropoda, such as members of the subphylums Crustacea, Arachnida, Insecta and the like. For example, the subphylum Crustacea comprises animals such as shrimp, lobster, and barnacle, while the subphylum Arachnida comprises animals such as spider, scorpion, and the like. In some embodiments, a member of the subphylum Insecta, which comprises animals such as bees, wasps, ants, beetles, cockchafers, flies, butterflies, moths, and the like, may be labeled.

In the present disclosure, the color or type of the paint or to be used is not limited so long as the paint's color can be altered through laser treatment. In some embodiments, the paint may be a white paint and/or may comprise calcium carbonate (CaCO₃) as one ingredient. For example, the paint may be a white poster paint.

In some embodiments, a method may comprise the following actions. First, the paint may be coated on a whole or a part of a body surface of a living organism, for example, on a surface of an exoskeleton or a similar structure of an insect. If an insect is being labeled, the paint may be coated on the insect's back, ventral of the insect's abdomen segment, or on the insect's thorax segment such as prothorax.

Next, a laser may be used to treat a portion of the paint but would not harm the body of the living organism. In an embodiment, a white poster paint may be used for labeling an insect, wherein the portion of the white poster paint that is treated by the laser is carbonized and exhibits a black color, but the untreated portion maintains its original white color. Accordingly, the white poster paint can be engraved by the laser with a symbol, pattern, or code, and can be used to produce a recognizable label on the body surface of the insect.

The parameters of laser engraving may depend on the laser apparatus used, but may be within about 20-50% of the maximum efficiency and about 20-50% of the maximum moving speed. These parameters may be adjusted depending the labeling mark desired. In some embodiments, about 25-35% of the maximum efficiency and about 25-35% of the maximum moving speed may be used. A label may be produced using anywhere from about one to about twenty laser treatments, for example, under the above-listed parameters for laser engraving.

During laser engraving, the living organism may be fixed to a fixing device to prevent movements that may negatively effect the size, shape, or accuracy of the labeling mark. The living organism may exhibit static or be in a coma via treatment such as gas anesthesia, refrigeration, and the like. Next, the living organism may be affixed to the fixing device. In order to enhance the label clarity and adherence, the target part of the body surface of the living organism may need to be cleaned. Then, the paint may be applied to (e.g., coated on) the target part and the laser engraving may be performed on it.

Advantageously, the method of the present disclosure for labeling a living organism by laser engraving does not injure the living organism or affect the behaviors and acts of the living organism. In addition, multiple living organisms can be labeled simultaneously, and automatic processing and automatic coding can be applied with a laser engraving system. Therefore, the present disclosure allows rapid and large-scale labeling, easy processing, safety for living organisms, easy observation, and the like.

### EXAMPLES

Some specific embodiments of the disclosure may be illustrated by one or more of the examples provided herein.

### Example 1

### Labeling a Honey Bee Through Laser Engraving

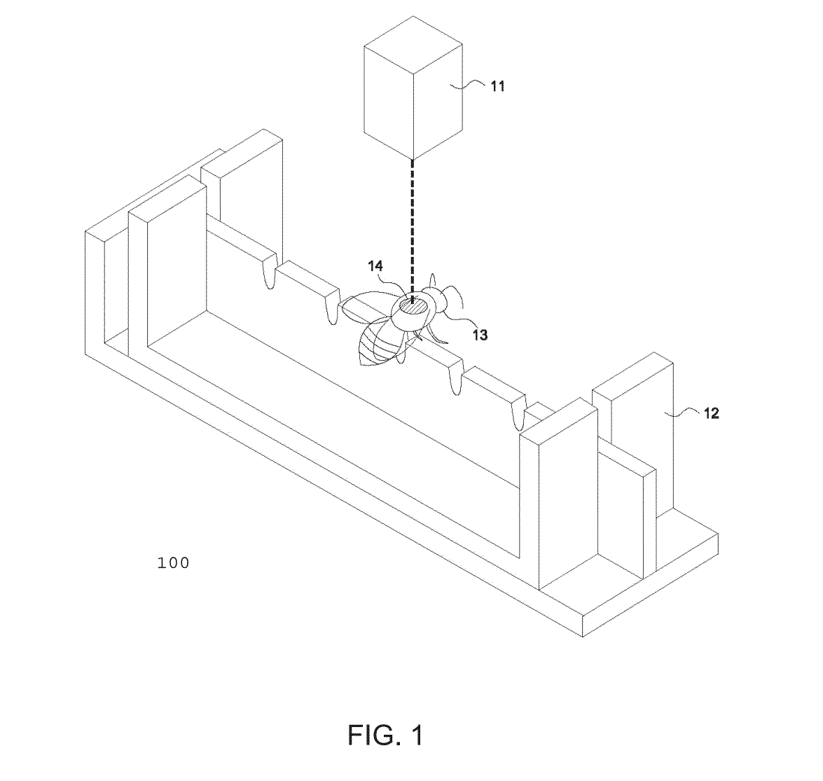

FIG. 1 illustrates a method 100 for labeling a living organism, in accordance with one embodiment of the present disclosure. In a first example, a honey bee 13 was subjected to approximately 0° C. temperatures for approximately 10 minutes to induce lethargy in honey bee 13. Honey bee 13 was next placed in a trench of a fixing device 12. The fixing device 12 may comprise multiple trenches, so that a plurality of honey bees 13 can be labeled simultaneously. The fixing device 13 may comprise up to twenty trenches. A white poster paint (in this example, a poster paint manufactured by Pentel Co., Ltd.) was next coated on a prothorax of honey bee 13 to form a coating 14 after scraping the dorsal seta on prothorax. The coating 14 may comprise a diameter of about 2-3 mm and may be about 0.1-0.4 mm thick.

A laser labeling device 11 was then used to perform the laser engraving on the coating 14 on prothorax of honey bee 13. In this example, the laser labeling device 11 (in this example, a type LES-10 laser manufactured by Laser Life Company) was used with its parameters set to 30% of the maximum efficiency and 30% of the maximum moving speed of to treat the coating 14 up to twenty times repeatedly. The maximum efficiency and the maximum moving speed of the laser labeling device 11 were about 10 W and about 762 mm/sec, respectively.

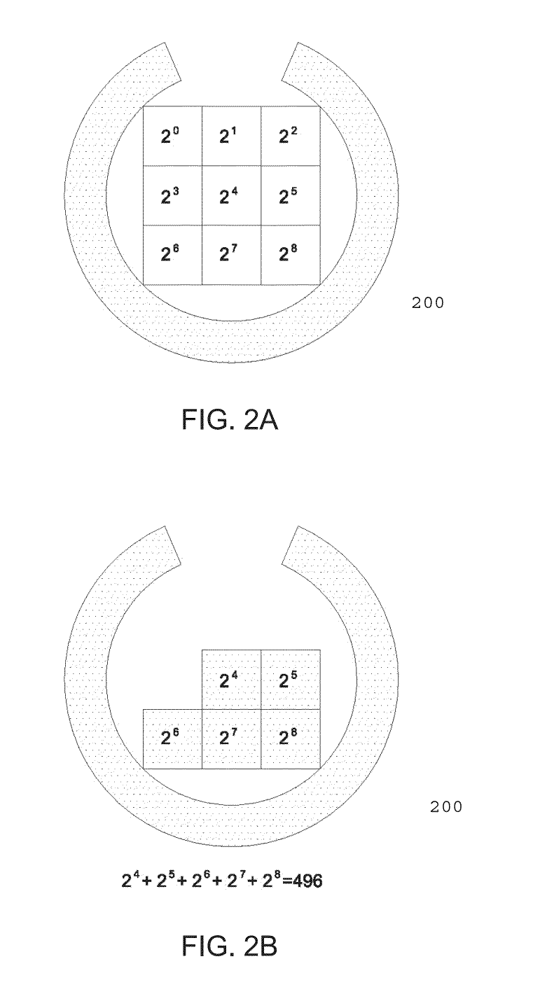

FIGS. 2A and 2B illustrate a two-dimensional image signals 200 used as labels, in accordance with one embodiment of the present disclosure. As shown in FIG. 2A, in a 3-by-3 grid, nine squares represent a sequence of binary digits. Black squares (i.e., dotted squares) may be used to represent that the value of the binary digit is one, while white squares (i.e., non-colored square) represents zero. Accordingly, any unique identifier label between 1 and 512 can be coded by using the 3-by-3 grid depicted in FIG. 2A. For example, FIG. 2B depicts a unique identifier label of 496 when the squares for 2⁴, 2⁵, 2⁶, 2⁷, and 2⁸ are shaded. When the values for each of the shaded squares are added up (i.e., 2⁴+2⁵+2⁶+2⁷+2⁸=496), the unique identifier equals 496.

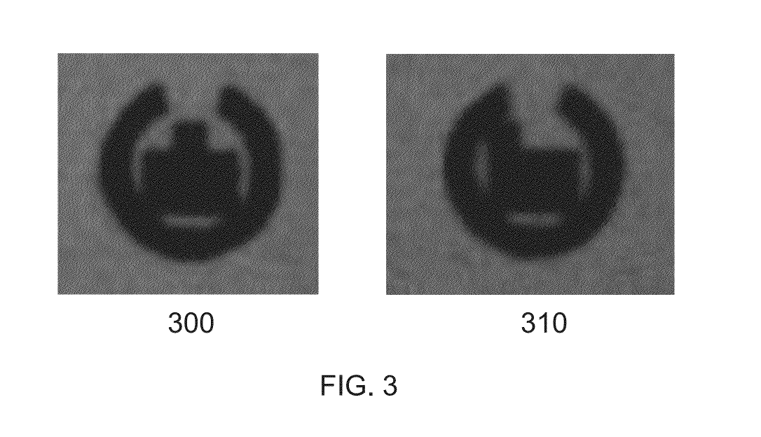

FIG. 3 illustrates two labels 300 of the two-dimensional image signal of FIG. 2 produced by a laser engraving, in accordance with one embodiment of the present disclosure. The labels produced by the laser engraving shown in FIG. 3 comprise the unique identifiers of 506 and 505, respectively. For example, the left-hand label depicts a unique identifier of 506 when the squares for 2¹, 2³, 2⁴, 2⁵, 2⁶, 2⁷, and 2⁸ are shaded (i.e., 2¹+2³+2⁴+2⁵+2⁶+2⁷+2⁸=506). For example, the right-hand label depicts a unique identifier of 505 when the squares for 2⁰, 2³, 2⁴, 2⁵, 2⁶, 2⁷, and 2⁸are shaded (i.e., 2⁰+2³+2⁴+2⁵+2⁶+2⁷+2⁸=505).

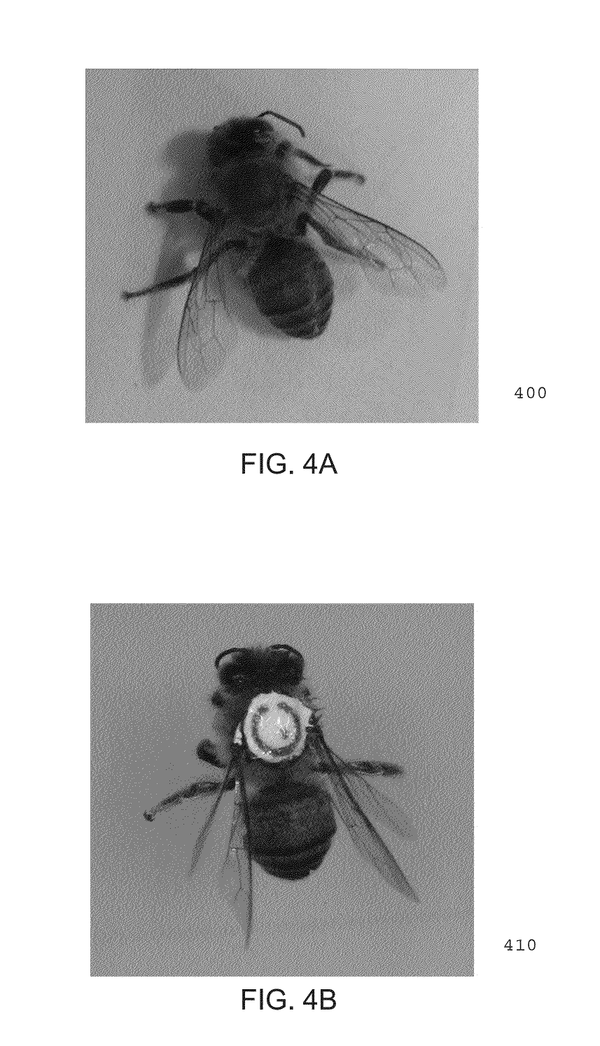

FIGS. 4A and 4B illustrate a honey bee labeled by the laser engraving of FIG. 3, in accordance with one embodiment of the present disclosure. An unlabeled honey bee 400 is shown in FIG. 4A and a labeled honey bee 410 labeled by laser engraving is shown in FIG. 4B. In FIG. 4B, the labeled honey bee 410 has a unique identifier of 256 (i.e., only the square representing 2⁸ is shaded).

According to some embodiments, a laser may engrave a coating surface merely by applying (e.g., repeatedly applying) suitable efficiencies and moving speeds of the laser to avoid causing injury to the living organism. Therefore, the label produced by laser engraving does not affect the honey bee. After being labeled, honey bees were observed with normal flying abilities and demonstrated normal interaction with other honey bees were observed. Therefore, honey bees in one honeycomb can be labeled and coded accordingly and can be observed and traced by a monitoring system without interfering with each honey bee's normal life.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims and its equivalent systems and methods.

What is claimed is:

1. A method for labeling a living organism by laser engraving, comprising:
fixing the living organism to a fixation device;
coating at least a part of a body surface of the living organism with a paint, wherein the paint is operable to react with a laser; and
reacting the paint with the laser to make a label by color alteration of the paint.

2. The method of claim 1, wherein the living organism has a rigid surface on at least a part of its body surface.

3. The method of claim 1, wherein the living organism has an exoskeleton.

4. The method of claim 1, wherein the living organism is a member of phylum Arthropoda.

5. The method of claim 4, wherein the living organism is an insect.

6. The method of claim 1, wherein the paint exhibits color alteration via laser reaction.

7. The method of claim 6, wherein the color alteration is from carbonization of a portion of the paint via the laser reaction

8. The method of claim 1, wherein the paint is a white paint.

9. The method of claim 8, wherein the white paint comprises calcium carbonate (CaCO₃).

10. The method of claim 1, wherein the laser reacts on the paint but not on the body of the living organism.

11. The method of claim 1, wherein the label comprises a symbol, pattern, or a code that is identifiable by visual inspection.

12. The method of claim 1, wherein the label comprises a three-by-three grid comprising a series of binary digits.

13. The method of claim 13, wherein the three-by-three grid may display a unique identifier for any value between 1 and 512.

14. A non-human living organism having a rigid surface on at least a part of its body surface, wherein at least a portion of the rigid surface comprises a paint coating with a laser-engraved identifier.

15. The living organism of claim 14, wherein the living organism has an exoskeleton.

16. The living organism of claim 14, wherein the living organism is a member of phylum Arthropoda.

17. The living organism of claim 16, wherein the living organism is an insect.
